(19) United States
(12) Patent Application Publication
(10) Pub. No.: US 2026/0220146 A1
(43) Pub. Date: Jul. 30, 2026

(54) QUERY PROCESSING METHOD, ELECTRONIC DEVICE AND STORAGE MEDIUM BASED ON A LARGE MODEL

(71) Applicant: BEIJING BAIDU NETCOM SCIENCE TECHNOLOGY CO., LTD., Beijing (CN)

(72) Inventors: Ruitian JIAN, Beijing (CN); Qingyang CHEN, Beijing (CN); Xiaoyu ZHANG, Beijing (CN); Ning LI, Beijing (CN); Kuan SHI, Beijing (CN)

(73) Assignee: BEIJING BAIDU NETCOM SCIENCE TECHNOLOGY CO., LTD., Beijing (CN)

(21) Appl. No.: 19/570,993

(22) Filed: Mar. 18, 2026

(30) Foreign Application Priority Data
Sep. 16, 2025 (CN) 202511324917.1

(51) Int. Cl. G06F 16/248; G06F 16/2455

(52) U.S. Cl. CPC G06F 16/248; G06F 16/24568

(57) ABSTRACT

A query processing method, an electronic device and a storage medium based on a large model, relating to artificial intelligence fields such as deep learning, large models, intelligent cloud, natural language processing and retrieval-augmented generation, are provided. The method may include: acquiring a target query to be processed; retrieving based on the target query from M predetermined data sources to obtain a first retrieval result, and inputting the target query and the first retrieval result into a target large model, where M is a positive integer; acquiring and displaying a target answer output by the target large model in a streaming output manner, where the target answer is an answer corresponding to the target query, and during a streaming output process, performing keyword recognition on output text content, and generating and displaying a knowledge card corresponding to a keyword.

### CROSS-REFERENCE TO RELATED APPLICATION

The present disclosure claims the priority and benefit of Chinese Patent Application No. 202511324917.1, filed on September 16, 2025, entitled “Query Processing Method, Apparatus, Electronic Device and Storage Medium Based on a Large Model”. The disclosure of the above application is incorporated herein by reference in its entirety.

### TECHNICAL FIELD

The present disclosure relates to the field of an artificial intelligence technology, particularly to the fields such as deep learning, large models, intelligent clouds, natural language processing and retrieval-augmented generation, and more particularly to a query processing method, an electronic device and a storage medium based on a large model.

### BACKGROUND

Currently, a question-answering process based on a large model typically includes: acquiring a query input by a user, inputting the query into a large model, and obtaining an answer (i.e., a response) generated by the large model. A large model typically refers to a Large Language Model (LLM), which is a deep learning model trained using a large amount of text data, capable of generating natural language text or understanding the meaning of the natural language text. By training on massive datasets, it can provide in-depth knowledge and language production on various topics.

### SUMMARY

The present disclosure provides a query processing method, an electronic device and a storage medium based on a large model.

A query processing method based on a large model, including:

acquiring a target query to be processed;

retrieving, based on the target query, from M predetermined data sources to obtain a first retrieval result, and inputting the target query and the first retrieval result into a target large model, where M is a positive integer;

acquiring and displaying a target answer output by the target large model in a streaming output manner, where the target answer is an answer corresponding to the target query, and during a streaming output process, performing keyword recognition on an output text content, and generating and displaying a knowledge card corresponding to a keyword.

An electronic device, including:

at least one processor; and

a memory communicatively connected to the at least one processor; where,

the memory stores instructions executable by the at least one processor to cause the at least one processor to perform the method as described above.

A non-transitory computer readable storage medium storing computer instructions for causing a computer to perform the method as described above.

It should be understood that the content described in this section is not intended to identify the key or important features of the embodiments of the present disclosure, nor is used to limit the scope of the present disclosure. Other features of the present disclosure will become readily understood through the following detailed description.

### BRIEF DESCRIPTION OF THE DRAWINGS

The drawings are used to better understand the present solution and do not constitute a limitation on the present disclosure, in which:

FIG. 1 is a flowchart of a query processing method based on a large model according to a first embodiment of the present disclosure;

FIG. 2 is a flowchart of a keyword recognition method for any content block according to an embodiment of the present disclosure;

FIG. 3 is a flowchart of a query processing method based on a large model according to a second embodiment of the present disclosure;

FIG. 4 is a schematic diagram showing a composition structure of a query processing apparatus 400 based on a large model according to an embodiment of the present disclosure; and

FIG. 5 shows a schematic block diagram of an electronic device 500 that may be used to implement an embodiment of the present disclosure.

### DETAILED DESCRIPTION OF EMBODIMENTS

The following part will illustrate exemplary embodiments of the present disclosure with reference to the drawings, including various details of the embodiments of the present disclosure for better understanding. The embodiments should be regarded only as exemplary ones. Therefore, those skilled in the art should appreciate that various changes or modifications can be made with respect to the embodiments described herein without departing from the scope and spirit of the present disclosure. Similarly, for clarity and conciseness, the descriptions of the known functions and structures are omitted in the descriptions below.

In addition, it should be understood that the term “and/or” only describes an association relationship between associated objects, and indicates that three relationships may exist. For example, A and/or B may indicate three cases: only A exists; both A and B exist; and only B exists. In addition, in this specification, the symbol “/” generally indicates that associated objects have a relationship of “or”.

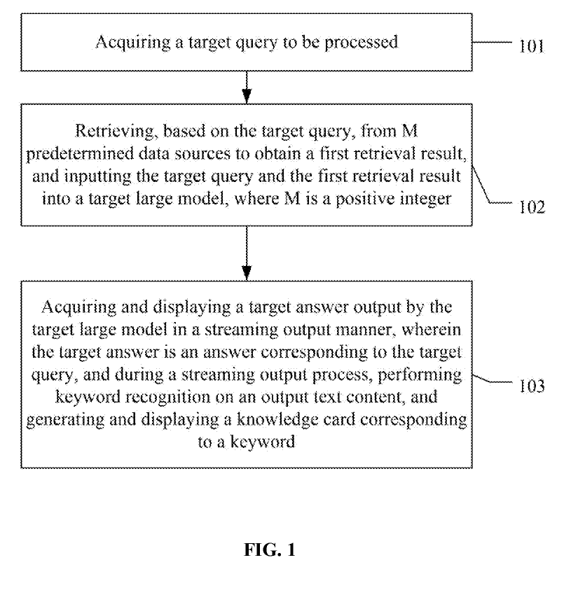

FIG. 1 is a flowchart of a query processing method based on a large model according to a first embodiment of the present disclosure. As shown in FIG. 1, the following specific implementation is included.

In step 101, acquiring a target query to be processed.

In step 102, retrieving, based on the target query, from M predetermined data source to obtain a first retrieval result, and inputting the target query and the first retrieval result into a target large model, where M is a positive integer.

In step 103, acquiring and displaying a target answer output by the target large model in a streaming output manner, where the target answer is an answer corresponding to the target query, and during a streaming output process, performing keyword recognition on an output text content, and generating and displaying a knowledge card corresponding to a keyword.

It can be seen that, with the solution described in the above method embodiment, after acquiring the target query, retrieving may first be performed based on the target query to obtain the first retrieval result, and then the target answer may be generated by combining the target query and the first retrieval result, i.e., the first retrieval result may be utilized to assist the target large model in generating the target answer, thereby improving the accuracy of the generated target answer, and moreover, the target large model may output the target answer in the streaming output manner, meaning that the generated text content may be output in real time, thereby reducing the user’s waiting time and improving the perceived response speed, and in addition, during the streaming output process, the following processing may also be performed in parallel: performing keyword recognition on the output text content and generating and displaying the knowledge card corresponding to a keyword, with the aid of the knowledge card, the user may better understand the target answer, thereby enhancing the readability and interpretability of the target answer, without affecting the streaming output process of the target answer, the two processes do not block each other, facilitating maintenance.

After acquiring the target query input by the user, retrieving may be performed based on the target query from the M predetermined data source to obtain the first retrieval result, and the specific value of M may be determined according to an actual need. For example, semantic understanding may first be performed on the target query to accurately recognize user requirement, and then retrieving may be performed, based on an understanding result, from multiple data sources including a database, a document set, and Internet, etc., thereby retrieving content related to the target query as the first retrieval result.

Thereafter, the target query and the first retrieval result may be input into the target large model to obtain the target answer output by the target large model in the streaming output manner. The target large model may perform model reading comprehension, and perform deep understanding, integration and generation of the target query and the first retrieval result to output the target answer with clear structure and accurate information.

The target large model may output the target answer in the streaming output manner. Streaming output refers to a process in which, when generating the text content, the large model does not wait until the entire content is fully computed before outputting it all at once, but instead returns results in an incremental manner, where the content output each time may be called an incremental content, and the incremental content output each time may include one or more characters. For example, assuming that a complete target answer is "Beijing, as an ancient capital of six dynasties, has gathered visitors from all directions and integrated culinary essences from various places, forming a unique Beijing-style cuisine, ..., We hope this list can help you start a delicious journey in Beijing", if a non-streaming output manner is adopted, it is necessary to wait until the complete target answer is generated before outputting it all at once to the user, but if the streaming output manner is adopted, the generated incremental content may be output to the user in real time. For instance. the first incremental content output may be "Beijing", the second incremental content output may be "as", the third incremental content output may be "an ancient capital of six dynasties", ..., until the complete target answer is output. The advantage of this output manner is that it can significantly improve user experience. The user can see part of the text content without waiting for a long time, thereby greatly reducing perceived latency and waiting anxiety. From a system perspective, the streaming output can also effectively reduce memory consumption and avoid buffer pressure caused by generating long text content, thereby improving system throughput capability and resource utilization, and in addition, the streaming output can support real-time interaction and dynamic correction, such as the user can timely interrupt an irrelevant response after obtaining effective information in an advance.

In the solution described in the present disclosure, during the streaming output process, the keyword recognition may be performed on the output text content, and the knowledge card corresponding to the keyword may be generated and displayed. In some embodiments of the present disclosure, during the streaming output process, in response to determining that each time the target large model outputs the incremental content, it may be determined whether a content block generation condition is met, and in response to determining that the content block generation condition is met, a predetermined text content may be determined as a content block, and the keyword recognition may be performed on the content block, where the predetermined text content is the incremental content that has been output and does not belong to any content block.

For example, assuming that the target large model sequentially outputs incremental content 1, incremental content 2, incremental content 3..., for each incremental content output, it is respectively determined whether the content block generation condition is met, assuming that when the target large model outputs incremental content 5, it is determined that the content block generation condition is met, then the "predetermined text content" at this time is incremental content 1 to incremental content 5, correspondingly, the text content corresponding to incremental content 1 to incremental content 5 may be determined as the content block, thereafter, assuming that when the target large model outputs incremental content 10, it is again determined that the content block generation condition is met, then the "predetermined text content" at this time is incremental content 6 to incremental content 10, correspondingly, the text content corresponding to incremental content 6 to incremental content 10 may be determined as another content block, and so on.

Through the above processing, real-time segmentation of the text content that has been output by the target large model may be achieved, thereby sequentially obtaining multiple different content blocks, which lays a good foundation for subsequent processing.

In one embodiment of the present disclosure, a statistical parameter may be set, where an initial value of the statistical parameter is 0, correspondingly, in response to determining that each time the target large model outputs the incremental content, the value of the statistical parameter may be incremented by 1, and the statistical parameter may be compared with a first threshold, in response to determining that the statistical parameter equals the first threshold, it may be determined that the content block generation condition is met, and the value of the statistical parameter may be reset to 0, where the first threshold is a positive integer greater than 1.

For example, assuming that the value of the first threshold is 5 and the initial value of the statistical parameter is 0, when the target large model outputs incremental content 1, the value of the statistical parameter becomes 1, when the target large model outputs incremental content 2, the value of the statistical parameter becomes 2, ..., when the target large model outputs incremental content 5, the value of the statistical parameter becomes 5, since the statistical parameter at this time equals the first threshold, it is determined that the content block generation condition is met, and the text content corresponding to incremental content 1 to incremental content 5 are determined as the content block, and the value of the statistical parameter is reset to 0, thereafter, when the target large model outputs incremental content 6, the value of the statistical parameter becomes 1 again, when the target large model outputs incremental content 7, the value of the statistical parameter becomes 2, ..., when the target large model outputs incremental content 10, the value of the statistical parameter becomes 5, since the statistical parameter at this time equals the first threshold, it is determined again that the content block generation condition is met, and the text content corresponding to incremental content 6 to incremental content 10 are determined as the another content block, and the value of the statistical parameter is reset to 0 again, and so on.

By adopting the above processing manner, generation frequency of the content block may be controlled through the statistical parameter and the first threshold, which is very flexible and convenient, and may meet different usage requirements of the user.

For each content block obtained, keyword recognition may be performed respectively. In some embodiments of the present disclosure, for any content block, a target input information may be respectively determined based on the content block, and the target input information may be input into a Named Entity Recognition (NER) model, thereby obtaining an entity identified from the content block, and the entity is determined as the keyword.

A named entity recognition is a fundamental task in the natural language processing, aiming to identify the entity with a specific meaning from the text, such as a professional term and a proper noun. By adopting a model to perform the named entity recognition, powerful reasoning capability of the model may be utilized to better understand contextual semantic, thereby improving the accuracy of a recognition result.

In some embodiments of the present disclosure, for any content block, when the target input information is determined based on the content block, a similar text of the content block may be retrieved from a predetermined knowledge base, where the knowledge base includes different candidate texts, and the similar text is the candidate text having a similarity with the content block greater than a second threshold, in response to determining that the similar text is retrieved, the target input information is determined based on the similar text and the content block, and in response to determining that no similar text is retrieved, the content block is directly determined as the target input information.

The knowledge base may be pre-generated, and which candidate text is specifically included may be determined according to the actual need. In addition, the specific value of the second threshold may also be determined according to the actual need.

In scenarios involving professional vocabularies, long-tail terms, or insufficient training coverage, if a content block is directly input into the named entity recognition model for recognition, situations may arise where entities cannot be recognized or are incorrectly recognized (a bad-case) may occur. For address this, the solution described in the present disclosure further introduces a Retrieval Augmented Generation (RAG) technology when performing entity recognition, i.e., when the entity recognition needs to be performed on any content block, similar text to the content block may first be retrieved from the knowledge base based on the similarity, if a match is found (similar text is retrieved), the target input information may be determined by combining the similar text and the content block, thereby utilizing the similar text to assist the named entity recognition model in recognizing the entity in the content block, if no match is found, entity recognition may be performed directly on the content block using the named entity recognition model.

With the aid of the similar text, the named entity recognition model may perform knowledge supplementation and disambiguation on the text content in the content block, thereby reducing the situations where entities cannot be recognized or are incorrectly recognized, i.e., reducing probability of missed detection and false detection, and further improving the accuracy of the recognition result.

In some embodiments of the present disclosure, for any content block, when the target input information is determined based on the similar text and the content block, in response to determining that the number of similar texts is less than or equal to L, where L is a positive integer, the target input information may be determined based on the similar texts and the content block, and in response to determining that the number of similar texts is greater than L, the similar texts may be sorted in a descending order of similarity, and the target input information may be determined based on top L similar texts after sorting and the content block. The specific value of L may be determined according to the actual need, such as 1 or 2.

That is, when the number of similar texts is too large, only L similar text(s) with highest similarity may be retained to reduce workload of the subsequent processing and improve processing efficiency.

In addition, in some embodiments of the present disclosure, for any content block, a manner of determining the target input information based on the similar text and the content block may include: extracting key information from the similar text, and determining the key information and the content block as the target input information, where the key information is configured to assist the named entity recognition model in recognizing the entity in the content block.

For example, the key information strongly correlated with the text content in the content block may be extracted from the similar text, where the key information may include definition, common alias/abbreviation and typical context. How to extract the key information is not limited, for example, a pre-trained extraction model may be utilized for extraction.

The similar text may be injected into the named entity recognition model in a form of a refined key point, in other words, it is equivalent to compressing the similar text and removing some content that is not very helpful for subsequent entity recognition, thereby avoiding impact on recognition process of the named entity recognition model and improving recognition efficiency of the entity recognition model.

In summary, through the above "block-wise retrieval and minimal necessary injection" processing manner, an effective remedial measure is provided for the bad-case involving professional vocabularies and long-tail terms.

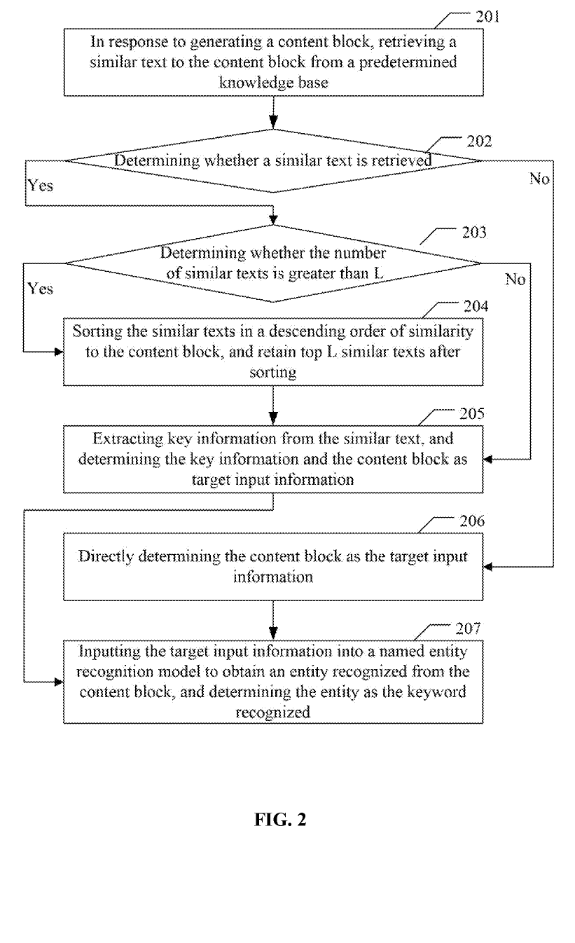

Combined with the above introduction, FIG. 2 is the flowchart of the keyword recognition method for any content block according to an embodiment of the present disclosure. As shown in FIG. 2, the following specific implementation is included.

In step 201, in response to generating a content block, a similar text of the content block is retrieved from a predetermined knowledge base.

In step 202, it is determined whether a similar text is retrieved, if yes, step 203 is executed, otherwise, step 206 is executed.

In step 203, it is determined whether the number of similar texts is greater than L, if yes, step 204 is executed, otherwise, step 205 is executed.

In step 204, the similar texts are sorted in a descending order of similarity to the content block, and top L similar texts after sorting are retained.

In step 205, key information is extracted from the similar text, the key information and the content block are determined as the target input information, and then step 207 is executed.

In step 206, the content block is directly determined as the target input information.

In step 207, the target input information is input into a named entity recognition model to obtain an entity identified from the content block, and the entity is determined as an identified keyword.

For any content block, after performing the keyword (entity) identification on the content block, for any identified keyword, the following processing may be performed: in response to determining that the keyword has not been added to a cache pool, adding the keyword to the cache pool, and in response to determining that the keyword has been added to the cache pool, discarding the keyword, correspondingly, when generating the knowledge card, taking out each keyword in the cache pool according to a first-in-first-out (FIFO) principle, and respectively generating the knowledge card corresponding to each taken-out keyword.

Assuming that a keyword a is identified from content block 3, and the keyword a is also identified from content block 2, then when processing the content block 2, the keyword a has already been added to the cache pool, correspondingly, the keyword a identified from content block 3 may be discarded to avoid generating a duplicate knowledge card and reduce resource consumption.

In addition, in some embodiments of the present disclosure, for the keywords in the cache pool, data sources may be asynchronously invoked for retrieval, i.e., for any keyword, when generating a corresponding knowledge card, retrieval may first be performed based on the keyword from N predetermined data sources to obtain a second retrieval result, where N is a positive integer, and then the knowledge card corresponding to the keyword may be generated based on the second retrieval result.

The specific value of N may be determined according to the actual need, such as 1, i.e., retrieval may be performed in a specified data source based on the keyword to obtain the second retrieval result, where the second retrieval result may include information such as an authoritative definition and a key attribute of the keyword.

Further, structured processing may be performed on the second retrieval result, such as extracting a specified type information therefrom, thereby streamlining the content in the second retrieval result, and the knowledge card may be generated based on the extracted specified type information, where a specific form of the knowledge card is not limited and may be determined according to actual need, which is very flexible and convenient.

In addition, in some embodiments of the present disclosure, when displaying any knowledge card, the knowledge card may be directly displayed in a card column, where the card column is a display area different from a display area for the target answer, or the keyword corresponding to the knowledge card may be displayed in the card column, and in response to determining that a display instruction for the keyword is acquired, the knowledge card may be displayed.

That is to say, a display interface may include at least two different display areas, respectively the display area for displaying the target answer and the above-mentioned card column. In this way, displaying the knowledge card will not cause any impact on the streaming output of the target answer, i.e., will not interrupt an output process of the target answer, and a more complete and a more fully explained answer content may be supplemented for the user through the knowledge card, achieving real-time enhancement of the answer content.

Acquiring the display instruction for the keyword may refer to detecting that the user has clicked on the keyword, or may refer to detecting that the user has moved a mouse over an area where the keyword is located, among others.

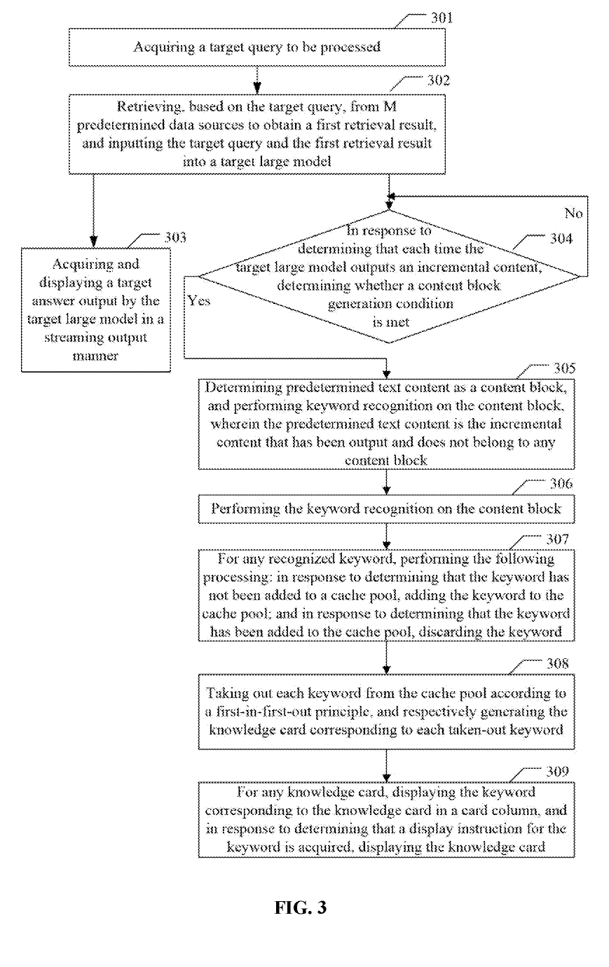

Based on the above introduction, FIG. 3 is the flowchart of of the query processing method based on the large model according to a second embodiment of the present disclosure. As shown in FIG. 3, the following specific implementation is included.

In step 301, a target query to be processed is acquired.

In step 302, retrieval is performed based on the target query from M predetermined data source to obtain a first retrieval result, and the target query and the first retrieval result are input into a target large model, and then steps 303 and steps 304-309 are executed in parallel.

In step 303, a target answer output by the target large model in a streaming output manner is acquired and displayed.

In step 304, in response to determining that each time the target large model outputs an incremental content, it is determined whether a content block generation condition is met, if yes, step 305 is executed, otherwise, step 304 is repeatedly executed.

For example, a statistical parameter may be set, where the initial value of the statistical parameter is 0, in response to determining that each time the target large model outputs an incremental content, the value of the statistical parameter may be incremented by 1, and the statistical parameter may be compared with a first threshold, in response to determining that the statistical parameter equals the first threshold, it may be determined that the content block generation condition is met, and the value of the statistical parameter may be reset to 0.

In step 305, the predetermined text content is determined as a content block, and keyword recognition is performed on the content block, where the predetermined text content is the incremental content that has been output and does not belong to any content block.

In step 306, the keyword recognition is performed on the content block.

A keyword recognition process may refer to FIG. 2.

In step 307, for any identified keyword, the following processing is performed respectively: in response to determining that the keyword has not been added to the cache pool, the keyword is added to the cache pool, and in response to determining that the keyword has been added to the cache pool, the keyword is discarded.

In step 308, the keyword in the cache pool is taken out according to a first-in-first-out (FIFO) principle, and a knowledge card corresponding to each taken-out keyword is generated respectively.

For example, for any keyword, retrieval may be performed based on the keyword from N predetermined data sources to obtain a second retrieval result, and then the knowledge card corresponding to the keyword may be generated based on the second retrieval result.

In step 309, for any knowledge card, the keyword corresponding to the knowledge card is displayed in the card column respectively, and in response to determining that a display instruction for the keyword is acquired, the knowledge card is displayed.

It should be noted that, for the sake of simplicity, the foregoing method embodiments are described as a series of action combinations. However, those skilled in the art should appreciate that the present disclosure is not limited by the described order of actions, as certain steps may be performed in other orders or concurrently in accordance with the present disclosure. Secondly, those skilled in the art should also appreciate that the embodiments described in the specification are all preferred embodiments, and the actions and modules involved are not necessarily essential to the present disclosure. Furthermore, for parts not detailed in a particular embodiment, reference may be made to relevant descriptions in other embodiments.

In summary, with the solution described in the present disclosure, while the target large model outputs the target answer in a streaming manner (a main process), keyword recognition and knowledge card generation may be performed in parallel on the output text content, thereby improving the accuracy, readability and information richness of the answer content output to the user. Moreover, experiments have shown that the resulting latency is remains within a controllable range and does not significantly affect a user experience.

The above is an introduction to the method embodiment, and the following further illustrates the solution described in the present disclosure through an apparatus embodiment.

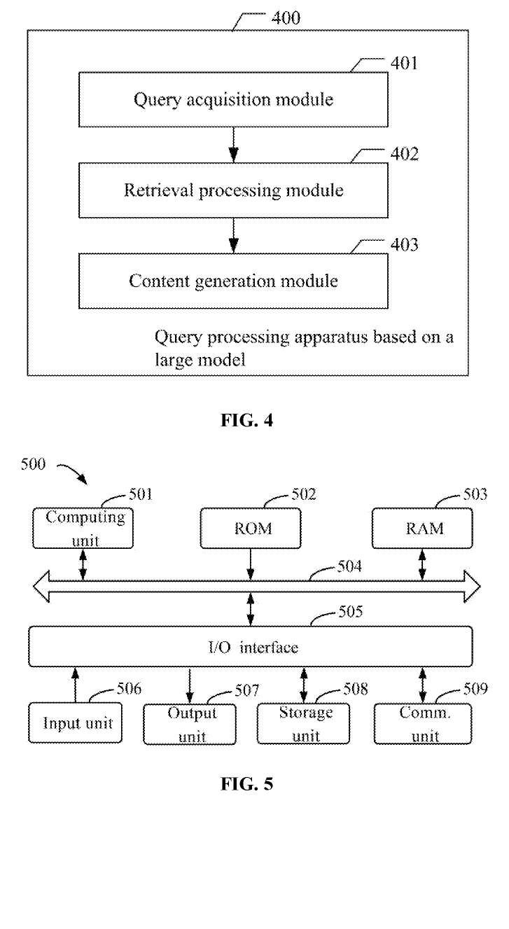

FIG. 4 is the schematic diagram showing the composition structure of a query processing apparatus 400 based on a large model according to an embodiment of the present disclosure. As shown in FIG. 4, it includes: a query acquisition module 401, a retrieval processing module 402, and a content generation module 403.

The query acquisition module 401 is configured to acquire a target query to be processed.

The retrieval processing module 402 is configured to perform the retrieval based on the target query from M predetermined data sources to obtain a first retrieval result, and input the target query and the first retrieval result into a target large model, where M is a positive integer.

The content generation module 403 is configured to acquire and display a target answer output by the target large model in the streaming output manner, where the target answer is an answer corresponding to the target query, and during a streaming output process, perform keyword recognition on the output text content, and generate and display a knowledge card corresponding to a keyword.

The query acquisition module 401 may acquire the target query input by the user, and then the retrieval processing module 402 may perform the retrieval based on the target query from the M predetermined data sources to obtain the first retrieval result, for example, semantic understanding may first be performed on the target query to accurately recognize user requirement, and then retrieving may be performed, based on an understanding result, from multiple data sources including a database, a document set, and Internet, etc., to obtain the first retrieval result, and the target query and the first retrieval result may be input into the target large model, correspondingly, the content generation module 403 may acquire and display the target answer output by the target large model in the streaming output manner, and during the streaming output process, the keyword recognition may be performed on the output text content, and the knowledge card corresponding to the keyword may be generated and displayed.

In some embodiments of the present disclosure, during the streaming output process, the content generation module 403, in response to determining that each time the target large model outputs an incremental content, may determine whether a content block generation condition is met, in response to determining that the content block generation condition is met, may determine predetermined text content as a content block, and may perform keyword recognition on the content block, where the predetermined text content is the incremental content that has been output and does not belong to any content block.

Specifically, in one embodiment of the present disclosure, the content generation module 403 may set a statistical parameter, where the initial value of the statistical parameter is 0, correspondingly, in response to determining that each time the target large model outputs the incremental content, the value of the statistical parameter may be incremented by 1, and the statistical parameter may be compared with a first threshold, in response to determining that the statistical parameter equals the first threshold, it may be determined that the content block generation condition is met, and the value of the statistical parameter may be reset to 0, where the first threshold is a positive integer greater than 1.

For each content block obtained, the content generation module 403 may perform the keyword recognition. In some embodiments of the present disclosure, for any content block, the content generation module 403 may determine target input information based on the content block, and may input the target input information into a named entity recognition model, thereby obtaining the entity recognized from the content block, and may determine the entity as the keyword.

Specifically, in some embodiments of the present disclosure, for any content block, when the content generation module 403 determines the target input information based on the content block, a similar text of the content block may be retrieved from a predetermined knowledge base, where the knowledge base includes different candidate texts, and the similar text is the candidate text having a similarity with the content block greater than a second threshold, in response to determining that the similar text is retrieved, the target input information may be determined based on the similar text and the content block, and in response to determining that no similar text is retrieved, the content block may be directly determined as the target input information.

In addition, in some embodiments of the present disclosure, for any content block, the content generation module 403, in response to determining that the number of similar texts is less than or equal to L, where L is a positive integer, may determine the target input information based on the similar texts and the content block, and in response to determining that the number of similar texts is greater than L, may sort the similar texts in a descending order of similarity, and may determine the target input information based on the top L similar texts after the sorting and the content block.

For any content block, when determining the target input information based on the similar text and the content block, in some embodiments of the present disclosure, the content generation module 403 may extract the key information from the similar text, and may determine the key information and the content block as the target input-information, where the key information is configured to assist the named entity recognition model in recognizing an entity in the content block.

For any content block, after performing the keyword recognition on the content block, for any identified keyword, the content generation module 403 may also perform the following processing: in response to determining that the keyword has not been added to a cache pool, adding the keyword to the cache pool, and in response to determining that the keyword has been added to the cache pool, discarding the keyword, correspondingly, when generating the knowledge card, the keyword in the cache pool may be taken out respectively according to a first-in-first-out (FIFO) principle, and the knowledge card corresponding to each taken-out keyword may be generated respectively.

In some embodiments of the present disclosure, for the keyword in the cache pool, the content generation module 403 may asynchronously invoke data sources for retrieval, i.e., for any keyword, when generating the corresponding knowledge card, the retrieval may first be performed based on the keyword from N predetermined data sources to obtain a second retrieval result, where N is a positive integer, and then the knowledge card corresponding to the keyword may be generated based on the second retrieval result.

In addition, in some embodiments of the present disclosure, when the content generation module 403 displays any knowledge card, the knowledge card may be directly displayed in a card column, where the card column is the a display area different from a display area for the target answer, or the keyword corresponding to the knowledge card may be displayed in the card column, and in response to determining that a display instruction for the keyword is acquired, the knowledge card may be displayed.

A specific workflow of the above apparatus embodiment may refer to relevant description in the aforementioned method embodiments, and will not be repeated here.

The solution described in the present disclosure may be applied to the field of artificial intelligence, particularly relating to the fields such as deep learning, large models, intelligent cloud, natural language processing and retrieval-augmented generation. Artificial intelligence is a discipline that studies how to make computers simulate certain human thinking processes and intelligent behaviors (such as learning, reasoning, thinking, planning, etc.), including both hardware-level and software-level technologies. Artificial intelligence hardware technologies generally include technologies such as sensors, dedicated artificial intelligence chips, cloud computing, distributed storage, and big data processing. Artificial intelligence software technologies mainly include computer vision technology, speech recognition technology, natural language processing technology, machine learning/deep learning, big data processing technology, knowledge graph technology and another major direction.

A query and an answer in the embodiment described in the present disclosure are not directed to any specific user and cannot reflect personal information of any specific user. In addition, an execution subject of the method described in the present disclosure may acquire the query through various public, legal and compliant means, such as acquiring from the user with a user authorization. In the technical solution of the present disclosure, the collection, storage, use, processing, transmission, provision and disclosure of user personal information involved all comply with relevant laws and regulations and do not violate public order and good customs.

According to an embodiment of the present disclosure, the present disclosure also provides an electronic device, a readable storage medium and a computer program product.

FIG. 5 shows the schematic block diagram of an electronic device 500 that may be used to implement the embodiments of the present disclosure. The electronic device is intended to represent various forms of digital computers, such as a laptop computer, a desktop computer, a workstation, a server, a blade server, a mainframe computer, and another suitable computers. The electronic device may also represent various forms of mobile devices, such as a personal digital assistant, a cellular phone, a smart phone, a wearable device and other similar computing devices. A component shown herein, their connections and relationships, and their functions are merely an example and are not intended to limit an implementation of the present disclosure described and/or claimed herein.

As shown in FIG. 5, the electronic device 500 includes a computing unit 501, which may execute various appropriate actions and processing according to a computer program stored in a Read-Only Memory (ROM) 502 or the computer program loaded from a storage unit 508 to a Random Access Memory (RAM) 503. In the RAM 503, various programs and data required for an operation of the electronic device 500 may also be stored. The computing unit 501, the ROM 502, and the RAM 503 are connected to each other through a bus 504. An Input/Output (I/O) interface 505 is also connected to the bus 504.

A plurality of components in the electronic device 500 are connected to the I/O interface 505, including: an input unit 506, such as a keyboard, a mouse, etc.; an output unit 507, such as various types of displays, speakers, etc.; a storage unit 508, such as a magnetic disk, an optical disk, etc.; and a communication unit 509, such as a network card, a modem, a wireless communication transceiver, etc. The communication (comm.) unit 509 allows the electronic device 500 to exchange information/data with another device through a computer network such as Internet and/or various telecommunication networks.

The computing unit 501 may be various general-purpose and/or dedicated processing components with processing and computing capability. Some examples of the computing unit 501 include but are not limited to a Central Processing Unit (CPU), a Graphic Processing Unit (GPU), various dedicated Artificial Intelligence (AI) computing chips, various computing units running a machine learning model algorithm, a Digital Signal Processing (DSP), and any appropriate processor, controller, micro-controller, etc. The computing unit 501 executes the various method and the processing described above, such as the method described in the present disclosure. For example, in some embodiments, the method described in the present disclosure may be implemented as a computer software program, which is tangibly contained in a machine-readable medium, such as the storage unit 508. In some embodiments, part or all of the computer programs may be loaded and/or installed onto the electronic device 500 via the ROM 502 and/or the communication unit 509. When the computer program is loaded into the RAM 503 and executed by the computing unit 501, one or more steps of the method described in the present disclosure may be performed. Alternatively, in other embodiments, the computing unit 501 may be configured to execute the method described in the present disclosure in any other appropriate manner (e.g., by means of a firmware).

Various implementations of the system and technique described above herein may be implemented in a digital electronic circuit system, an integrated circuit system, a Field Programmable Gate Array (FPGA), an Application Specific Integrated Circuit (ASIC), an Application Specific Standard Part (ASSP), a System on Chip (SOC), a Complex Programmable Logic Device (CPLD), a computer hardware, a firmware, a software, and/or a combination thereof. These various implementations may include: an implementation in one or more computer programs, where the one or more computer programs may be executed and/or interpreted on a programmable system including at least one programmable processor, where the programmable processor may be a dedicated or a general-purpose programmable processor, may receive data and instructions from a storage system, at least one input device, and at least one output device, and transmit the data and the instructions to the storage system, the at least one input device, and the at least one output device.

Program codes for implementing the method of the present disclosure may be written in any combination of one or more programming languages. These program codes may be provided to the processor or the controller of a general-purpose computer, a special-purpose computer or another programmable data processing apparatus, such that when the program codes are executed by the processor or the controller, a function/operation specified in a flowchart and/or a block diagram is implemented. The program codes may be executed entirely on a machine, partly on the machine, as a standalone software package partly on the machine and partly on a remote machine, or entirely on the remote machine or a server.

In the context of the present disclosure, the machine-readable medium may be a tangible medium that may contain or store a program for use by or in connection with an instruction execution system, an apparatus, or a device. The machine-readable medium may be a machine-readable signal medium or a machine-readable storage medium. The machine-readable medium may include but is not limited to an electronic, a magnetic, an optical, an electromagnetic, an infrared, or a semiconductor system, an apparatus or a device, or any suitable combination of the above content. A more specific example of the machine-readable storage medium would include an electrical connection based on one or more wires, a portable computer disk, a hard disk, a random access memory, a read-only memory, an Electronically Programmable Read-Only Memory (EPROM), a flash memory, an optical fiber, a portable Compact Disc Read-Only Memory (CD-ROM), an optical storage device, a magnetic storage device, or any suitable combination of the above content.

To provide an interaction with a user, the system and the technique described herein may be implemented on a computer having: a display device for displaying the information to the user (e.g., a Cathode Ray Tube (CRT) or a Liquid Crystal Display (LCD) monitor); and the keyboard and a pointing device (e.g., the mouse or a trackball) through which the user may provide an input to the computer. Another kind of a device may also be used to provide the interaction with the user; for example, a feedback provided to the user may be any form of a sensory feedback (e.g., a visual feedback, an auditory feedback, or a tactile feedback); and the input from the user may be received in any form (including an acoustic input, a speech input, or a tactile input).

The system and the technique described herein may be implemented in a computing system that includes a back-end component (e.g., as a data server), or the computing system that includes a middleware component (e.g., an application server), or the computing system that includes a front-end component (e.g., a user computer having a graphical user interface or a web browser through which the user may interact with the implementation of the system and the technique described herein), or the computing system that includes any combination of such back-end, middleware, or front-end component. The component of the system may be interconnected by any form or a medium of a digital data communication (e.g., a communication network). An example of the communication network includes: a Local Area Network (LAN), a Wide Area Network (WAN), and the Internet.

A computer system may include a client and a server. The client and the server are generally remote from each other and typically interact through the communication network. A relationship of the client and the server arises by virtue of a computer program running on a respective computer and having a client-server relationship to each other. The server may be a cloud server, or a server of a distributed system, or a server combined with a block-chain.

It should be understood that various forms of a process shown above may be used, with a step reordered, added or deleted. For example, the steps described in the present disclosure may be executed in parallel, sequentially, or in a different order, as long as a desired result of the technical solution disclosed in the present disclosure can be achieved, which is not limited herein.

The above specific implementations do not constitute a limitation on a protection scope of the present disclosure. Those skilled in the art should understand that the various modification, combination, sub-combination and substitution may be made according to a design requirement and other factors. Any modification, equivalent substitution and improvement made within the spirit and principle of the present disclosure should be included within the protection scope of the present disclosure.

What is claimed is:

1. A query processing method based on a large model, comprising:
acquiring a target query to be processed;
retrieving, based on the target query, from M predetermined data sources to obtain a first retrieval result, and inputting the target query and the first retrieval result into a target large model, where M is a positive integer; and
acquiring and displaying a target answer output by the target large model in a streaming output manner, wherein the target answer is an answer corresponding to the target query, and during a streaming output process, performing keyword recognition on an output text content, and generating and displaying a knowledge card corresponding to a keyword.

2. The method according to claim 1, wherein the performing keyword recognition on the output text content comprises:
during the streaming output process, in response to determining that each time the target large model outputs an incremental content, determining whether a content block generation condition is met; and
in response to determining that the content block generation condition is met, determining predetermined text content as a content block, and performing keyword recognition on the content block, wherein the predetermined text content is the incremental content that has been output and does not belong to any content block.

3. The method according to claim 2, further comprising:
setting a statistical parameter, wherein an initial value of the statistical parameter is 0;
wherein determining whether the content block generation condition is met in response to determining that each time the target large model outputs the incremental content comprises:
in response to determining that each time the target large model outputs the incremental content, incrementing the value of the statistical parameter by 1; and
comparing the statistical parameter with a first threshold, and in response to determining that the statistical parameter equals the first threshold, determining that the content block generation condition is met, and resetting the value of the statistical parameter to 0, wherein the first threshold is a positive integer greater than 1.

4. The method according to claim 2, wherein the performing keyword recognition on the content block comprises:
determining target input information based on the content block; and
inputting the target input information into a named entity recognition model to obtain an entity recognized from the content block, and determining the entity as the keyword.

5. The method according to claim 4, wherein the determining the target input information based on the content block comprises:
retrieving a similar text to the content block from a predetermined knowledge base, wherein the knowledge base comprises different candidate texts, and the similar text is a candidate text having a similarity with the content block greater than a second threshold; and
in response to determining that the similar text is retrieved, determining the target input information based on the similar text and the content block, and in response to determining that no similar text is retrieved, directly determining the content block as the target input information.

6. The method according to claim 5, wherein the determining the target input information based on the similar text and the content block comprises:
in response to determining that the number of similar texts is less than or equal to L, where L is a positive integer, determining the target input information based on the similar texts and the content block; and
in response to determining that the number of similar texts is greater than L, sorting the similar texts in a descending order of similarity, and determining the target input information based on top L similar texts after sorting and the content block.

7. The method according to claim 5, wherein the determining the target input information based on the similar text and the content block comprises:
extracting key information from the similar text; and
determining the key information and the content block as the target input information, wherein the key information is configured to assist the named entity recognition model in recognizing the entity in the content block.

8. The method according to claim 2, further comprising:
after the performing keyword recognition on the content block, for any recognized keyword, performing the following processing: in response to determining that the keyword has not been added to a cache pool, adding the keyword to the cache pool; and in response to determining that the keyword has been added to the cache pool, discarding the keyword;
wherein the generating the knowledge card corresponding to the keyword comprises: taking out each keyword from the cache pool according to a first-in-first-out principle, and respectively generating the knowledge card corresponding to each taken-out keyword.

9. The method according to claim 1, wherein the generating the knowledge card corresponding to the keyword comprises:
retrieving, based on the keyword, from N predetermined data sources to obtain a second retrieval result, where N is a positive integer; and
generating the knowledge card corresponding to the keyword according to the second retrieval result.

10. The method according to claim 1, wherein the displaying comprises:
for any knowledge card, directly displaying the knowledge card in a card column, wherein the card column is a display area different from a display area for the target answer.

11. The method according to claim 1, wherein the displaying comprises:
for any knowledge card, displaying the keyword corresponding to the knowledge card in the card column, and in response to determining that a display instruction for the keyword is acquired, displaying the knowledge card.

12. An electronic device, comprising:
at least one processor; and
a memory communicatively connected to the at least one processor; wherein,
the memory stores instructions executable by the at least one processor to cause the at least one processor to perform a query processing method based on a large model, comprising:
acquiring a target query to be processed;
retrieving, based on the target query, from M predetermined data sources to obtain a first retrieval result, and inputting the target query and the first retrieval result into a target large model, where M is a positive integer; and
acquiring and displaying a target answer output by the target large model in a streaming output manner, wherein the target answer is an answer corresponding to the target query, and during a streaming output process, performing keyword recognition on an output text content, and generating and displaying a knowledge card corresponding to a keyword.

13. The electronic device according to claim 12, wherein the performing keyword recognition on the output text content comprises:
during the streaming output process, in response to determining that each time the target large model outputs an incremental content, determining whether a content block generation condition is met; and
in response to determining that the content block generation condition is met, determining predetermined text content as a content block, and performing keyword recognition on the content block, wherein the predetermined text content is the incremental content that has been output and does not belong to any content block.

14. The electronic device according to claim 13, wherein the method further comprises:
setting a statistical parameter, wherein an initial value of the statistical parameter is 0;
wherein determining whether the content block generation condition is met in response to determining that each time the target large model outputs the incremental content comprises:
in response to determining that each time the target large model outputs the incremental content, incrementing the value of the statistical parameter by 1; and
comparing the statistical parameter with a first threshold, and in response to determining that the statistical parameter equals the first threshold, determining that the content block generation condition is met, and resetting the value of the statistical parameter to 0, wherein the first threshold is a positive integer greater than 1.

15. The electronic device according to claim 13, wherein the performing keyword recognition on the content block comprises:
determining target input information based on the content block; and
inputting the target input information into a named entity recognition model to obtain an entity recognized from the content block, and determining the entity as the keyword.

16. The electronic device according to claim 15, wherein the determining the target input information based on the content block comprises:
retrieving a similar text to the content block from a predetermined knowledge base, wherein the knowledge base comprises different candidate texts, and the similar text is a candidate text having a similarity with the content block greater than a second threshold; and
in response to determining that the similar text is retrieved, determining the target input information based on the similar text and the content block, and in response to determining that no similar text is retrieved, directly determining the content block as the target input information.

17. The electronic device according to claim 16, wherein the determining the target input information based on the similar text and the content block comprises:
in response to determining that the number of similar texts is less than or equal to L, where L is a positive integer, determining the target input information based on the similar texts and the content block; and
in response to determining that the number of similar texts is greater than L, sorting the similar texts in a descending order of similarity, and determining the target input information based on top L similar texts after sorting and the content block.

18. The electronic device according to claim 16, wherein the determining the target input information based on the similar text and the content block comprises:
extracting key information from the similar text; and
determining the key information and the content block as the target input information, wherein the key information is configured to assist the named entity recognition model in recognizing the entity in the content block.

19. The electronic device according to claim 13, wherein the method further comprises:
after the performing keyword recognition on the content block, for any recognized keyword, performing the following processing: in response to determining that the keyword has not been added to a cache pool, adding the keyword to the cache pool; and in response to determining that the keyword has been added to the cache pool, discarding the keyword;
wherein the generating the knowledge card corresponding to the keyword comprises: taking out each keyword from the cache pool according to a first-in-first-out principle, and respectively generating the knowledge card corresponding to each taken-out keyword.

20. A non-transitory computer readable storage medium storing computer instructions for causing a computer to perform a query processing method based on a large model, comprising:
acquiring a target query to be processed;
retrieving, based on the target query, from M predetermined data sources to obtain a first retrieval result, and inputting the target query and the first retrieval result into a target large model, where M is a positive integer; and
acquiring and displaying a target answer output by the target large model in a streaming output manner, wherein the target answer is an answer corresponding to the target query, and during a streaming output process, performing keyword recognition on an output text content, and generating and displaying a knowledge card corresponding to a keyword.
